(19) United States
(12) Patent Application Publication
(10) Pub. No.: US 2010/0312368 A1
(43) Pub. Date: Dec. 9, 2010

(54) Aural Audio Player

(76) Inventor: Anthony Rodriguez, Las Vegas, NV (US)

Correspondence Address: Anthony Rodriguez, 5292 S. Maryland Parkway #114, Las Vegas, NV, 89119, US

(21) Appl. No.: 12/479,685

(22) Filed: Jun. 5, 2009

(51) Int. Cl. G06F 17/00

(52) U.S. Cl. 700/94

(57) ABSTRACT

This aural audio player is portable and uses a digital memory device to provide the aural information while the user uses the actual print material for the visual aid. The book or magazine can be read in a visual mode, as print, or in an aural mode, as the spoken word corresponding to the print, or in both visual and aural modes. The audio player may be conveniently attached to any flat print media for the purpose or listening while viewing the printed material. In addition, some versions the audio player can be easily attached or removed from the print material or flat sided object at any time.

### FIELD OF THE INVENTION

This invention relates to information storage and display apparatus and more particularly to a portable, electronic audio device, which plays stored miniaturized and encoded information and plays the information through a thin electrical digital unit attached to print media.

### BACKGROUND OF THE INVENTION

Printed-paper is the traditional medium for books. Other than minor changes in paper, binding, and ink technologies, the form of books has not changed significantly in centuries. This is changing as electronics and computers are altering the nature, authoring, publishing, cost, and form of books.

Electronics are being incorporated into all aspects of society and especially in the field of communications. With the introduction of the computer and the Internet into everyday life, the written word, including the book, is one of the primary technologies impacted by this revolution. Book technology is changing in several directions.

The printed word in books, magazines, and newspapers has expanded from paper editions to audio versions and electronic versions. Audio books provide an aural rendition of the words in the book and use a cassette tape or digital electronic disk as a medium for the information and require an electronic apparatus for the expression of the information.

Audio books have found limited popularity among reading-disabled persons and travelers. An audio book may include enhancements such as celebrities reading the book, appropriate multiple voices for the various characters in the story, and other audible enhancements such as music and sound effects, which add to the enjoyment of the book. The overwhelming preference for the visual book, however, limits the popularity of the audio book.

The electronic book has taken two forms. The first form is the paper book with electronic sensors built into the pages, which activate an audio component. The technology enhances the reading experience. A book of this form, however, is expensive to manufacture, in part because the electronic components are dedicated to a single title.

The second form of electronic book does not use paper, but instead uses an electronic display to present electronic text. Such books appear in a variety of configurations.

A third form is that of a combination of the two, a printed media and an electronic audio device together.

U.S. Pat. No. 4,159,417 discloses a portable, electronic viewer, which reads stored, miniaturized information and displays the information on a thin electronic screen. Although a variety of digital storage media is disclosed, the preferred embodiment used a hologram. The viewer was constructed with two facing electronic screen “sheets” and resembled a book in that sense.

U.S. Pat. No. 5,167,508 discloses an electronic book with multiple leaves each of which are multilayered with a sheet with printed material mounted against a sheet with diodes.

The diodes are sequentially lighted, thereby sequentially illuminating portions of the book, and an audible discussion of the printed materials provided by a voice synthesizer in sequence with the illumination.

U.S. Pat. No. 5,239,665 discloses an electronic book, which retrieves information from memory media such as floppy disks or laser cards. In addition, the information may be received by telephonic or wireless means. This book allows the reader to adjust the reading speed to that used in reading books, magazines or newspapers.

U.S. Pat. No. 5,339,091 discloses a visual only electronic book with a single visual display unit, which displays information from floppy disks. The book is powered by a battery or solar cell.

U.S. Pat. No. 5,417,575 discloses an electronic book with multiple pages formed from a single folded sheet of circuitry. Printed images laminated on the pages are illuminated sequentially and synchronized audible signals provide enhancing information, for example, informing the reader of alternative progressing choices, such as touching or pressing a portion of an image on the page in order to enter a game.

U.S. Pat. No. 5,631,883 discloses an ordinary book of printed texts in conjunction with an audio device with a ROM, which audibly reads portions of the book corresponding to the opened pages. Information on which pages are open is provided by reflective tabs on the margin of each page.

U.S. Pat. No. 5,761,485 discloses a personal electronic book with facing pages each with several icons which, when touched, calls up the appropriate cover page for a printed product or for a video or audio clip. The book is linked via a cellular telephone to a network which provides content.

U.S. Pat. No. 5,802,516 discloses a touchscreen method of controlling the screen display of an electronic book using an electronic pen or stylus for navigating the table of contents.

None of these prior art devices achieve the goals of the present invention, that is, of providing a portable, digital audio device associated with and temporarily connected to printed media.

### SUMMARY OF THE INVENTION

A thin-profile digital audio player sized to attach to the top or side edge of printed content, which include print media. This digital audio player is suggested to use 126, 256 or 512 megabytes of memory along with suitable D/A converters and audio amplification circuitry to allow audio playback via thin-film speaker transducers or via headset connection. The audio player makes use of industry standard formats for digital audio recording (MP3, wma, etc.) with suitable compression techniques for efficient use of memory capacity.

The device replaces the need for CDs to be included with instructional books, children's books, bibles, promotional CDs in magazines or audio books It can be attached to any flat sided object, such as notebooks, folders or keyboards to store audio notes, memos, or indexes or be used to improve printed presentational pieces and stationary such as reports, maps, pictures, note books, etc,

The Aural audio player is basically an audio player [like an mp3 player] that is designed to be attached to books or any other flat object or printed media via an extended plastic piece that extends across it. It has a plug for headphones on one end, buttons across it for playback, recording, etc, and can vary with having an LCD screen, speaker or usb plug

### BRIEF DESCRIPTION OF THE DRAWINGS (V4 “La Lengua” Model)

FIG. 1 is the front side view of the device

FIG. 2 is the perspective view of the front/top of the device

FIG. 3 is the back side view of the device.

FIG. 4 is the bottom view of the device

FIG. 5 is the left side view of the device

FIG. 6 is the top view of the device

FIG. 7 is the right side view of the device

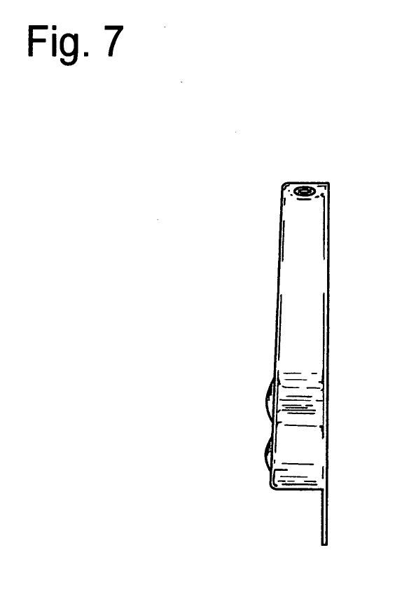

### DESCRIPTION OF THE PREFERRED EMBODIMENT

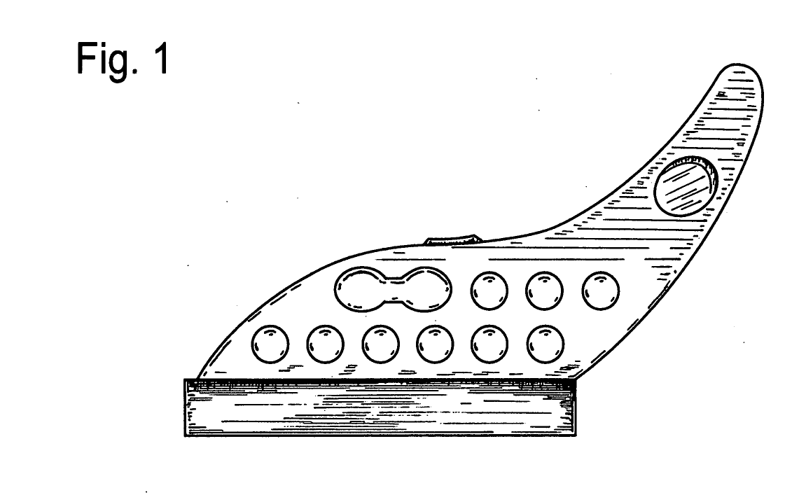

FIG. 1

a. USB port—used for uploading, downloading or transferring audio contents. Charges the player.

b. Next/Forward and Previous/Backward track button—used to go to specific tracks or cue points, fast forward or rewind tracks.

c. Volume slider—used to increase or decrease volume level.

d. Headphone Jack—used to plug in headphones for listening.

e. LCD display screen—Used to show track number, time lapse, chapter, or mode.

f. Operational Buttons—used to play, stop, pause or record specific or all tracks.

g. Optional second row of operational buttons [many models only have one row of buttons]—used to play, stop, pause or record specific or all tracks.

h. Extended Bonding piece—used to attach player [temporarily or permanently] to other objects, such as print media, folder, books, maps, pictures, etc, . . . In certain models the player can be detached from the extended bonding piece, may have a glue strip, mounting brackets, clips, or other types of fasteners for attachment or detachment.

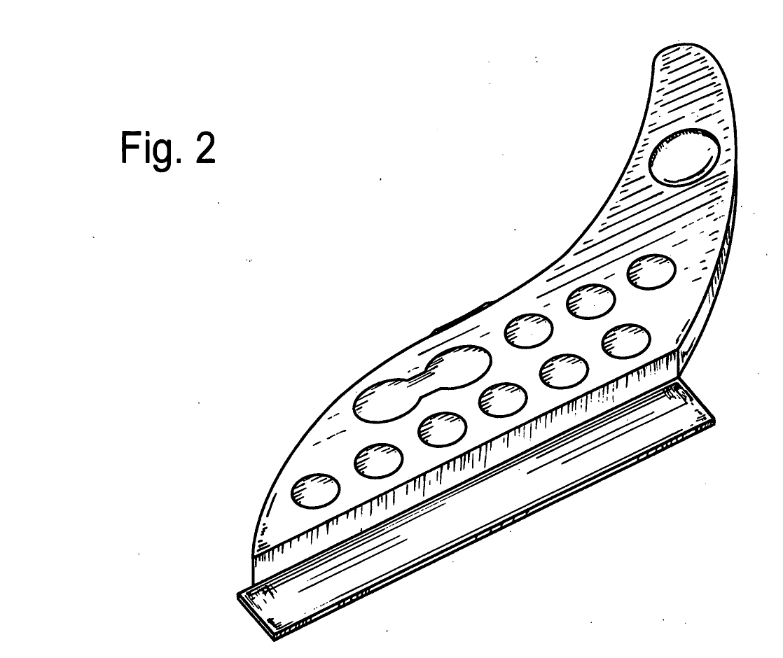

FIG. 2

a. USB port—used for uploading, downloading or transferring audio contents. Charges the player.

b. Next/Forward and Previous/Backward track button—used to go to specific tracks or cue points, fast forward or rewind tracks.

c. Volume slider—used to increase or decrease volume level.

d. Headphone Jack—used to plug in headphones for listening.

e. LCD display screen—Used to show track number, time lapse, chapter, or mode.

f. Operational Buttons—used to play, stop, pause or record specific or all tracks.

g. Optional second row of operational buttons [many models only have one row of buttons]—used to play, stop, pause or record specific or all tracks.

h. Extended Bonding piece—used to attach player [temporarily or permanently] to other objects, such as print media, folder, books, maps, pictures, etc, . . . In certain models the player can be detached from the extended bonding piece, may have a glue strip, mounting brackets, clips, or other types of fasteners for attachment or detachment.

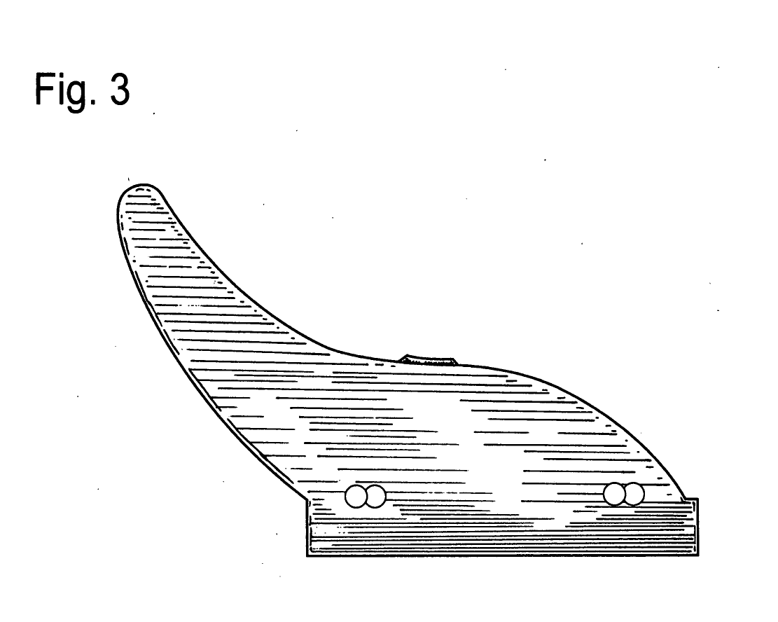

FIG. 3

a. USB port—used for uploading, downloading or transferring audio contents. Charges the player.

b. Volume slider—used to increase or decrease volume level.

c. Headphone Jack—used to plug in headphones for listening.

d. Extended Bonding piece—used to attach player [temporarily or permanently] to other objects, such as print media, folder, books, maps, pictures, etc, . . . In certain models the player can be detached from the extended bonding piece, may have a glue strip, mounting brackets, clips, or other types of fasteners for attachment or detachment.

FIG. 3b

a. USB port—used for uploading, downloading or transferring audio contents. Charges the player.

b. Volume slider—used to increase or decrease volume level.

c. Headphone Jack—used to plug in headphones for listening.

d. Player Mounts [Not on ever model]—used to attach/detach player from the extended bonding piece

e. Extended Bonding piece—used to attach player [temporarily or permanently] to other objects, such as print media, folder, books, maps, pictures, etc, . . . In certain models the player can be detached from the extended bonding piece, may have a glue strip, mounting brackets, clips, or other types of fasteners for attachment or detachment.

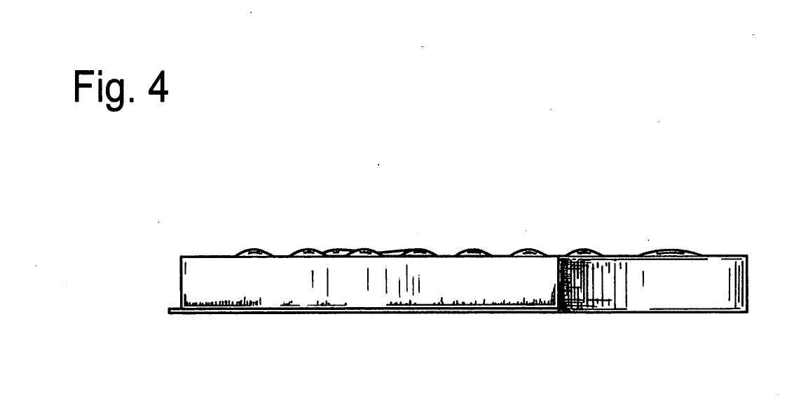

FIG. 4

a. “Snap” brackets—player snaps into for attachment or removed from for detachment, allowing the player to be portable and independent of the object that the extended bonding piece in attached to.

b. Volume slider—used to increase or decrease volume level.

c. Operational Buttons—used to play, stop, pause or record specific or all tracks.

d. Extended Bonding piece—used to attach player [temporarily or permanently] to other objects, such as print media, folder, books, maps, pictures, etc, . . . In certain models the player can be detached from the extended bonding piece, may have a glue strip, mounting brackets, clips, or other types of fasteners for attachment or detachment.

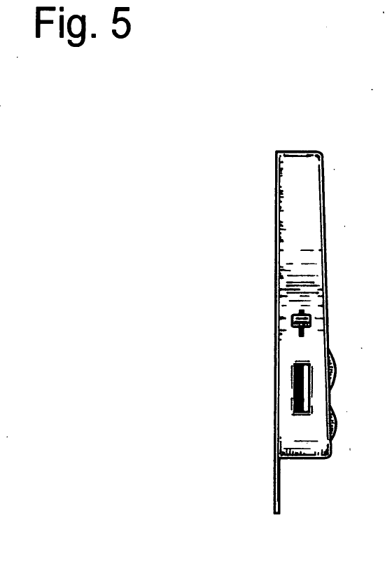

FIG. 5

a. Extended Bonding piece—used to attach player [temporarily or permanently] to other objects, such as print media, folder, books, maps, pictures, etc, . . . In certain models the player can be detached from the extended bonding piece, may have a glue strip, mounting brackets, clips, or other types of fasteners for attachment or detachment.

b. Operational Buttons—used to play, stop, pause or record specific or all tracks.

c. USB port—used for uploading, downloading or transferring audio contents. Charges the player.

d. Volume slider—used to increase or decrease volume level.

e. Headphone Jack—used to plug in headphones for listening.

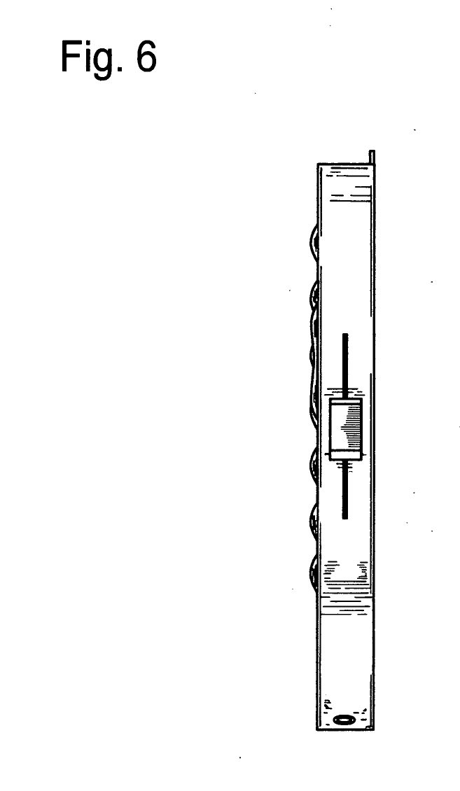

FIG. 6

a. Extended Bonding piece—used to attach player [temporarily or permanently] to other objects, such as print media, folder, books, maps, pictures, etc, . . . In certain models the player can be detached from the extended bonding piece, may have a glue strip, mounting brackets, clips, or other types of fasteners for attachment or detachment.

b. Operational Buttons—used to play, stop, pause or record specific or all tracks.

c. Volume slider—used to increase or decrease volume level.

d. Headphone Jack—used to plug in headphones for listening

What is claimed is

1. A portable digital aural audio player with printed material or a flat sided object attachment that may be comprised of, but not limited to:
a. An extended bonding piece for attaching to print material or flat sided objects
b. USB port
c. Operational buttons
d. Headphone jack
e. LCD display screen
f. Recording microphone
g. Playback speaker

2. A portable aural digital audio player with printed material or flat sided object attachment of claim 1 wherein the device embodies a recording device for personal effects, notes, commentary, music or prerecorded content.

3. A portable aural digital audio player with printed material or flat sided object attachment of claim 1 wherein the player can be disposed of after use.

4. A portable aural digital audio player with printed material or flat sided object attachment of claim 1 wherein the device incorporates the use of LCD screen for uploading information or instructional material.

5. A portable aural digital audio player with printed material flat sided object attachment of claim 1 wherein the device embodies wireless technology.

6. A portable aural digital audio player with printed material flat sided object attachment of claim 1 wherein the player can be independently removed from the printed material or flat sided object and reattached.

7.

This aural audio player is portable and uses a digital memory device to provide the aural information while the user uses the actual print material for the visual aid. The book or magazine can be read in a visual mode, as print, or in an aural mode, as the spoken word corresponding to the print, or in both visual and aural modes. The audio player may be conveniently attached to any flat print media for the purpose or listening while viewing the printed material. In addition, some versions the audio player can be easily attached or removed from the print material or flat sided object at any time.

What is claimed is:

1. A portable digital aural audio player with printed material or a flat sided object attachment that may be comprised of, but not limited to:
a. An extended bonding piece for attaching to print material or flat sided objects
b. USB port
c. Operational buttons
d. Headphone jack
e. LCD display screen
f. Recording microphone
g. Playback speaker

2. A portable aural digital audio player with printed material or flat sided object attachment of claim 1 wherein the device embodies a recording device for personal effects, notes, commentary, music or prerecorded content.

3. A portable aural digital audio player with printed material or flat sided object patent of claim 1 wherein the player can be disposed of after use.

4. A portable aural digital audio player with printed material or flat sided object attachment of claim 1 wherein the device incorporates the use of LCD screen for uploading information or instructional material.

5. A portable aural digital audio player with printed material flat sided object attachment of claim 1 wherein the device embodies wireless technology.
